(19) United States
(12) Patent Application Publication
(10) Pub. No.: US 2023/0267246 A1
(43) Pub. Date: Aug. 24, 2023

(54) METHOD FOR CONSTRUCTING GENERAL PROBABILITY MODEL OF HARMONIC EMISSION LEVEL FOR INDUSTRIAL LOAD

(71) Applicant: SICHUAN UNIVERSITY, Chengdu (CN)

(72) Inventors: Ying WANG, Chengdu (CN); Mengjie YU, Chengdu (CN); Xianyong XIAO, Chengdu (CN); Yunzhu CHEN, Chengdu (CN); Wengxi HU, Chengdu (CN)

(73) Assignee: SICHUAN UNIVERSITY, Chengdu (CN)

(21) Appl. No.: 18/082,626

(22) Filed: Dec. 16, 2022

(30) Foreign Application Priority Data
Feb. 24, 2022 (CN) 202210172447.1

(51) Int. Cl. G06F 30/20; G06F 17/18

(52) U.S. Cl. CPC G06F 30/20; G06F 17/18

(57) ABSTRACT

A method for constructing a general probability model of a harmonic emission level for an industrial load is provided. The method establishes, based on harmonic data monitored by a power quality monitoring system, a general probability model by combining a parametric estimation method based on a normal distribution function and a lognormal distribution function with a nonparametric estimation method represented by a kernel density estimation method, taking a degree of approximation between the general probability model and an actual probability distribution of each harmonic current as an objective function based on parameters required by the general probability model, and optimizing and solving the parameters of the proposed general probability model by using a multiplier method to determine parameters of the general probability model to finally obtain a general probability model applicable to different industrial loads.

### CROSS REFERENCE TO THE RELATED APPLICATIONS

This application is based upon and claims priority to Chinese Patent Application No. 202210172447.1, filed on Feb. 24, 2022, the entire contents of which are incorporated herein by reference.

### TECHNICAL FIELD

The present disclosure relates to the technical field of power quality of a power system and, specifically, to a method for constructing a general probability model of a harmonic emission level for an industrial load.

### BACKGROUND

With the continuous development of the industrial level, more large-capacity, nonlinear, and impulsive loads are applied in a power system, which results in an increasingly serious harmonic problem in the power system. To improve the power quality of the power system, grid companies have carried out a series of operations, such as harmonic power flow calculation, harmonic responsibility division, and harmonic resonance analysis based on accurate modeling of a harmonic load. It can be seen that harmonic modeling of a large industrial load is of great significance for harmonic hazard assessment and governance.

At present, there are mainly two types of harmonic load modeling methods. One type of harmonic load modeling method is based on a circuit principle and mechanism analysis. Based on a volt-ampere characteristic between a harmonic voltage and a harmonic current, this method mainly obtains an equivalent current source model that can represent a coupling relationship between each harmonic voltage and current of a harmonic source or a harmonic coupling admittance matrix model based on an RLC circuit. This method generally needs to provide measured voltage and current waveform data to analyze a harmonic generation mechanism. In this method, it is difficult to obtain waveform data, the mechanism analysis process is complex, and there are single modeling objects and the like. The other type of harmonic load modeling method is based on monitoring data or simulation data and data analysis and mainly includes a machine learning method and a probabilistic method. There are two types of probabilistic methods based on whether a distribution form of a required variable needs to be preset, namely, a nonparametric estimation method and a parametric estimation method. The parametric estimation method selects a different probability density function (such as a normal distribution function, a lognormal distribution function, or the like) based on the actual probability distribution form of the variable and uses a maximum likelihood method or other parametric estimation method to solve a numerical characteristic of the probability density function. The parametric estimation method is generally only applicable to data with a known distribution form and a single peak value. Without assuming a probability density function that the nonparametric estimation method may meet, the nonparametric estimation method directly analyzes a probability density function of actual data through histogram estimation, kernel density estimation, or Monte Carlo simulation. However, the nonparametric estimation method lacks theoretical guidance, and a calculation result is easily affected by bandwidth. Therefore, it is difficult to directly apply the nonparametric estimation method to practical projects.

With the popularization of a power quality monitoring system, a bus outlet of a large industrial load is usually equipped with a power quality monitoring device to monitor the power quality of the industrial load in real-time, such as a total harmonic voltage/current distortion rate, a harmonic voltage ratio, an effective harmonic value, and the like, which provides a solid data basis for accurate modeling of a harmonic emission level of the large industrial load. Under such technical background, this patent proposes a general probability model of a harmonic emission level for an industrial load based on power quality monitoring data, which further improves model accuracy and scalability.

1) The modeling method based on the mechanism analysis needs to measure the waveform data of actual voltage and current of a load and obtains, based on the volt-ampere characteristic between the harmonic voltage and the harmonic current, the equivalent current source model that represents the coupling relationship between each harmonic voltage and current of the harmonic source or the harmonic coupling admittance matrix model based on the RLC circuit. The modeling method performs the analysis based on monitoring of the waveform data, and monitoring data in an actual power system is mainly steady-state power quality data monitored by the power quality monitoring system. Therefore, it is difficult to perform analysis directly. In addition, a mechanism analysis process is also very complex, and a specific load needs to be analyzed in a specific manner, which results in poor universality or scalability.

2) The single probability model analysis method needs to determine the distribution form of the variable in advance and select an appropriate probability distribution function based on the distribution form to perform analysis. Harmonic data of an actual load is distributed in a multi-peak and asymmetric form, so it is difficult to find a suitable probability density distribution function for analysis.

### SUMMARY

To resolve the above problems, the present disclosure provides a method for constructing a general probability model of a harmonic emission level for an industrial load to combine a parametric estimation method based on a normal distribution function and a lognormal distribution function with a nonparametric estimation method represented by a kernel density estimation method. This not only overcomes the disadvantage that a single probability distribution model depends on pilot experience and cannot be applied to a multi-peak and asymmetric distribution but also avoids an insufficient theoretical basis of a kernel density estimation method, thereby effectively improving the accuracy and adaptability of modeling. The technical solutions are as follows:

A method for constructing a general probability model of a harmonic emission level for an industrial load includes the following steps:

Step 1: extracting harmonic monitoring data of an industrial load to obtain a harmonic characteristic dataset X of a user:

$$X = [ \begin{matrix}{I}_{2}^{1} & {I}_{3}^{1} & L & {I}_{25}^{1} \\ {I}_{2}^{2} & {I}_{3}^{2} & L & {I}_{25}^{2} \\ M & M & M & M \\ {I}_{2}^{N} & {I}_{3}^{N} & L & {I}_{25}^{N}\end{matrix} ] ,$$

where N represents the total quantity of sampling points, each column vector in the X represents a harmonic current monitoring sequence, a subscript of I represents a harmonic order, and a superscript of the I represents the quantity of sampling sequences.

Step 2: constructing a general probability model for an h-th harmonic Iₕ in the harmonic characteristic dataset:

$$f ( {I}_{h} ) = {\sum }_{i = 1}^{3} {λ}_{i} {f}_{i} ( {I}_{h} ) ,$$

where fᵢ(.) represents a probability density subfunction, λᵢ represents a weight coefficient of the probability density subfunction; the general harmonic probability model is a linear combination of three probability density subfunctions, where f₁(.) represents a part that is of the Iₕ and obeys a normal distribution, f₂(.) represents a part that is of the Iₕ and obeys a lognormal distribution, and f₃(.) represents a part that is of the Iₕ and obeys another distribution. fᵢ(.) is expressed as follows:

$${f}_{1} ( {I}_{h} ) = \frac{1}{\sqrt{2 π} {σ}_{1}} {e}^{- \frac{( {I}_{h} - {μ}_{1} )}{2 {σ}_{1}^{2}}} , \\ {f}_{2} ( {I}_{h} ) = \frac{1}{\sqrt{2 π} {I}_{h} {σ}_{2}} {e}^{- \frac{{( {lnI}_{h} - {μ}_{2} )}^{2}}{2 {σ}_{2}^{2}}} , and \\ {f}_{3} ( {I}_{h} ) = \frac{1}{nb} {\sum }_{j = 1}^{n} K ( \frac{{I}_{h} - {I}_{h}^{j}}{b} ) ,$$

where μ₁ and μ₂ represent mathematical expectations of the probability density subfunction; σ₁ and σ₂ represent standard deviations of the probability density subfunction; K(.) represents a kernel function b>0, where b represents a smoothing parameter, which is referred to as a bandwidth or a window; Iₕ^{j} represents a j^{th} sample of the Iₕ in each window; n represents the total quantity of samples in each window.

The probability density function is non-negative and normative, so the weight coefficient of the probability density subfunction should meet the following formula, where λ₁=1 or λ₂=1, indicating that the Iₕ obeys a single normal distribution or the lognormal distribution:

$${\sum }_{i = 1}^{3} {λ}_{i} = 1 ( 0 \leq {λ}_{i} \leq 1 ) .$$

Step 3: discretizing the general probability model of the Iₕ, where

the Iₕ is discretized to discretize the f₁(.) and the f₂(.) to obtain the following discretized general harmonic probability model:

$$f ( {\tilde{I}}_{h} ) = {\sum }_{i = 1}^{3} {λ}_{i} {f}_{i} ( {\tilde{I}}_{h} ) , {\tilde{I}}_{h} = 0 : 0.01 : max ( {I}_{h} ) ,$$

where max(Iₕ) represents the maximum current value of the h-th harmonic.

Step 4: constructing a parameter optimization model of the general probability model, which specifically includes the following substeps:

Step 4.1: constructing an objective function, where

a degree of approximation between the general probability model and an actual probability distribution of the Iₕ is reflected by the difference between a mathematical expectation calculated by a general optimization model and an actual value, as well as a difference between a standard deviation calculated by the general optimization model and the actual value, and therefore the objective function is as follows:

$$min {y}_{1} = {( {\sum }_{i = 1}^{3} {λ}_{i} {E}_{i} ( {\tilde{I}}_{h} ) - {E}_{0} ( {\tilde{I}}_{h} ) )}^{2} and \\ min {y}_{2} = {( \sqrt{{\sum }_{i = 1}^{3} {λ}_{i}^{2} {Var}_{i} ( {\tilde{I}}_{h} )} - \sqrt{{Var}_{0} ( {\tilde{I}}_{h} )} )}^{2}$$

where y₁ and y₂ respectively represent mean square errors of a mathematical expectation and a standard deviation of the general probability model; Eᵢ(Īₕ) and E₀(Īₕ) respectively represent a mathematical expectation that is of the Iₕ and calculated by the probability density subfunction and an actual mathematical expectation of the Iₕ; Varᵢ(Īₕ) and Var₀(Īₕ) respectively represent a standard deviation that is of the Iₕ and calculated by the probability density subfunction and an actual standard deviation of the Iₕ.

Two minimum objective functions are combined into a minimum objective function, and the combined minimum objective function is as follows:

$$min y = \frac{{y}_{1} + {y}_{2}}{2} .$$

Step 4.2: determining constraints, where

the constraints include an equality constraint and an inequality constraint.

1) The equality constraint for optimizing the variable λᵢ is determined according to the following formula and is expressed by l:

$$l = {\sum }_{i = 1}^{3} {λ}_{i} - 1 = 0.$$

2) The inequality constraint includes a value range of the weight coefficient λᵢ and a value range that is of the random variable Iₕ and determined by numerical characteristics (μ₁, σ₁) and (μ₂, σ₂) when the single probability density subfunction takes effect.

Step 5: solving parameters {λ₁, λ₂, λ₃, μ₁, μ₂, σ₁, σ₂} of the general probability model.

A constrained problem is converted into an unconstrained problem. A multiplier method is used for solving, that is, an optimization variable set is defined as γ={λ₁, λ₂, λ₃, μ₁, μ₂, σ₁, σ₂}. An augmented Lagrange function is defined as J and is expressed is as follows:

$$J ( γ , ω , ν , ρ ) = y ( γ ) - ν l ( γ ) + \frac{ρ}{2} {l}^{2} ( γ ) + \frac{1}{2 ρ} {\sum }_{q = 1}^{11} \{ {[ max ( 0 , {ω}_{q} - ρ {g}_{q} ( γ ) ) ]}^{2} - {ω}_{q}^{2} \} ,$$

where y(γ) represents the objective function, l(γ) represents the equality constraint, g_{q}(γ) represents the inequality constraint, ω_{q} represents a Lagrange multiplier of the inequality constraint, and ν represents a Lagrange multiplier of the equality constraint.

For the J(γ, ω, ν, ρ), only the sufficiently large parameter ρ needs to be taken, and the multipliers ω and ν are continuously corrected to obtain a local optimal solution by minimizing the J(γ, ω, ν, φ, where correction formulas of the multipliers ω and ν are as follows:

$$\{ \begin{matrix}{ω}_{q}^{( k + 1 )} = max ( 0 , {ω}_{q}^{( k )} - ρ {g}_{q} ( {γ}^{( k )} ) ) , q = 1 , 2 , L , 11 \\ {ν}^{( k + 1 )} = {ν}^{( k )} - ρ l ( {γ}^{( k )} )\end{matrix} ,$$

where k is a superscript that represents a quantity of corrections.

Step 6: obtaining the general probability model of the Iₕ.

Further, in the objective function in Step 4.1,

$${E}_{1} ( {\tilde{I}}_{h} ) = {μ}_{1} , \\ {Var}_{1} ( {\tilde{I}}_{h} ) = {σ}_{1}^{2} , {E}_{2} ( {\tilde{I}}_{h} ) = {e}^{{μ}_{2} + {σ}_{2}^{2} / 2} , \\ {Var}_{2} ( {\tilde{I}}_{h} ) = ( {e}^{{σ}_{2}^{2}} - 1 ) {e}^{2 {μ}_{2} + {σ}_{2}^{2}} , {E}_{3} ( {\tilde{I}}_{h} ) = {\sum }_{j = 1}^{{N}_{1}} {\tilde{I}}_{h}^{j} p ( {\tilde{I}}_{h} ) , {Var}_{3} ( {\tilde{I}}_{h} ) = {\sum }_{j = 1}^{{N}_{1}} {( {\tilde{I}}_{h}^{j} - {E}_{3} ( {\tilde{I}}_{h} ) )}^{2} p ( {\tilde{I}}_{h}^{j} ) , \\ {N}_{1} = length ( {\tilde{I}}_{h} ) , \\ and p ( {\tilde{I}}_{h}^{j} ) = \frac{{f}_{3} ( {\tilde{I}}_{h}^{j} )}{sum ( {f}_{3} ( {\tilde{I}}_{h} ) )} .$$

Further, in step 4.2, an inequality constraint of the λᵢ is as follows:

$$\{ \begin{matrix}{g}_{1} = {λ}_{1} \geq 0 \\ {g}_{2} = {λ}_{2} \geq 0 , \\ {g}_{3} = {λ}_{3} \geq 0\end{matrix}$$

where assuming that 95% confidence intervals of {μ₁, μ₂, σ₁, σ₂} are [\hat{θ}₁, \hat{θ}₂], [\hat{θ}₃, \hat{θ}₄], [\hat{θ}₅, \hat{θ}₆], and [\hat{θ}₇, \hat{θ}₈] respectively, inequality constraints of the optimization variables {μ₁, μ₂, σ₁, σ₂} are as follows:

$$\{ \begin{matrix}{g}_{4} = {μ}_{1} - {\hat{θ}}_{1} \geq 0 \\ {g}_{5} = {\hat{θ}}_{2} - {μ}_{1} \geq 0\end{matrix} , \\ \{ \begin{matrix}{g}_{6} = {μ}_{2} - {\hat{θ}}_{3} \geq 0 \\ {g}_{7} = {\hat{θ}}_{4} - {μ}_{2} \geq 0\end{matrix} , \\ \{ \begin{matrix}{g}_{8} = {σ}_{1} - {\hat{θ}}_{5} \geq 0 \\ {g}_{9} = {\hat{θ}}_{6} - {σ}_{1} \geq 0\end{matrix} , and \\ \{ \begin{matrix}{g}_{10} = {σ}_{2} - {\hat{θ}}_{7} \geq 0 \\ {g}_{11} = {\hat{θ}}_{8} - {σ}_{2} \geq 0\end{matrix} ,$$

where g_{q} represents the inequality constraint and q=1, 2, L, 11.

Further, the multiplier method in step 5 specifically includes the following substeps:

step a: setting an initial point γ⁽⁰⁾, initial multiplier vector estimates ω⁽¹⁾ and ν⁽¹⁾, a parameter ρ, an allowable error ε (>0), a constant c (>1), β (∈(0,1)), and k (=1);

step b: taking γ^{(k-1)} as an initial point and solving an unconstrained problem shown in the following formula to obtain a solution γ^{(k)}:

min J(γ,ω^{(k)},ν^{(k)},ρ);

step c: if ∥l(γ^{(k)})∥<ε, stopping the calculation and obtaining a point γ^{(k)}); otherwise, performing step d;

step d: ∥l(γ^{(k)})∥/∥l(γ^{(k-1)})∥≥β, setting ρ=cρ and performing step e; otherwise, performing step e directly; and

step e: correcting multipliers ω_{q}^{(k+1)} and ν^{(k+1)} by using the second formula in step 5, setting k=k+1, and performing step b.

The present disclosure achieves the following beneficial effects: The present disclosure establishes, based on harmonic data monitored by a power quality monitoring system, a general probability model by combining a parametric estimation method based on a normal distribution function and a lognormal distribution function with a nonparametric estimation method represented by a kernel density estimation method, taking a degree of approximation between the general probability model and an actual probability distribution of each harmonic current as an objective function based on parameters required by the model, and optimizing and solving the parameters of the proposed general probability model by using a multiplier method to determine parameters of the general probability model to finally obtain a general probability model applicable to different industrial loads. The present disclosure not only overcomes the disadvantage that a single probability distribution model depends on pilot experience and cannot be applied to a multi-peak and asymmetric distribution but also avoids an insufficient theoretical basis of a kernel density estimation method, thereby effectively improving the accuracy and adaptability of modeling.

### BRIEF DESCRIPTION OF THE DRAWINGS

FIG. 1 is a basic flowchart according to the present disclosure;

FIG. 2 shows measured data of a harmonic current; and

FIG. 3 is a basic flowchart of a multiplier method.

### DETAILED DESCRIPTION OF THE EMBODIMENTS

The present disclosure will be further described below in conjunction with the accompanying drawings and specific embodiments.

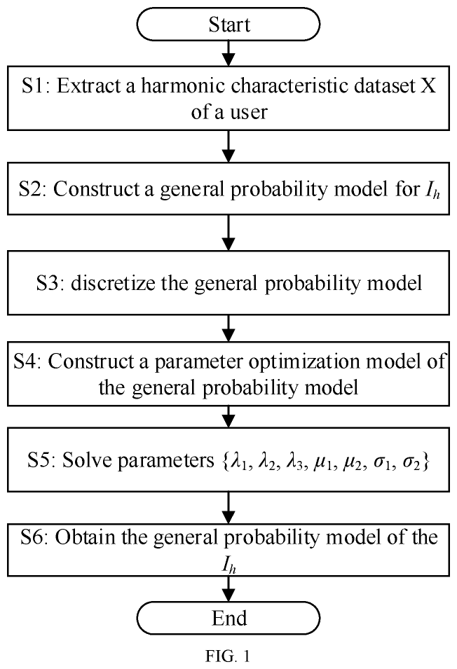

An industrial load has a large capacity and accounts for a large proportion, which imposes a great impact on the power quality of a power system. To accurately depict a harmonic problem caused by the industrial load to a grid, the present disclosure provides a general probability model of a harmonic emission level for an industrial load. A basic flowchart is shown in FIG. 1, which is divided into six steps, namely, S1 to S6.

S1: Harmonic monitoring data of an industrial load is extracted to obtain harmonic characteristic dataset X of a user.

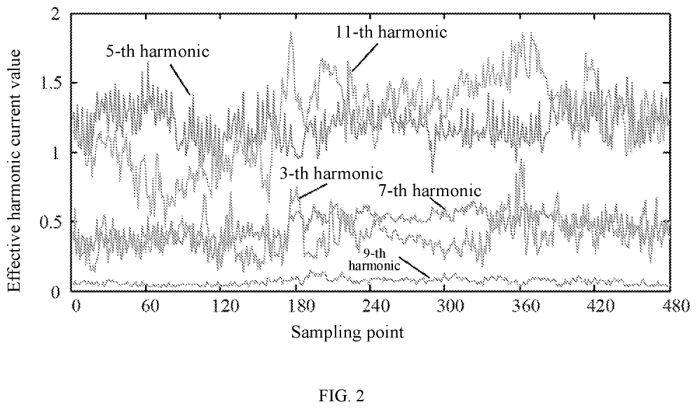

A bus inlet of the industrial load bus is usually equipped with a power quality monitoring device whose sampling interval is generally 3 to 15 min. Monitoring data mainly includes maximum values, minimum values, average values, and the 95% of the maximum value of a fundamental voltage, a fundamental current, active power, reactive power, apparent power, a total harmonic voltage/current distortion rate, a 2 to 25-th harmonic voltage ratio/effective current values, and the like. The present disclosure is intended to use an average value of a 2 to 25-th harmonic current measured at a 3-min sampling interval on Dec. 20, 2021, in a 110 kV steelmaking plant in Taiyuan City, Shanxi Province to perform the analysis. FIG. 2 shows monitoring data of several harmonic currents. Finally, the harmonic characteristic dataset X of the user can be obtained.

$$X = [ \begin{matrix}{I}_{2}^{1} & {I}_{3}^{1} & L & {I}_{25}^{1} \\ {I}_{2}^{2} & {I}_{3}^{2} & L & {I}_{25}^{2} \\ M & M & M & M \\ {I}_{2}^{N} & {I}_{3}^{N} & L & {I}_{25}^{N}\end{matrix} ] . \qquad ( 1 )$$

In the above formula, N represents the total quantity of sampling points and is equal to 480 herein. Each column vector in the X represents a harmonic current monitoring sequence, a subscript of I represents a harmonic order, and a superscript of the I represents the quantity of sampling sequences. For example, Iₕ^{m} represents an m^{th} sampling point of an h-th harmonic; j=1, 2, . . . , 480; h represents a harmonic order; and h=2, 3, . . . , 25.

Step 2: A general probability model is constructed for the h-th harmonic (Iₕ) in the harmonic characteristic dataset, as shown in the following formula (2):

$$f ( {I}_{h} ) = {\sum }_{i = 1}^{3} {λ}_{i} {f}_{i} ( {I}_{h} ) . \qquad ( 2 )$$

In the above formula, fᵢ(.) represents a probability density subfunction, and λᵢ represents the weight coefficient of the probability density subfunction. The general harmonic probability model is a linear combination of three probability density subfunctions. f₁(.) represents a part that is of the Iₕ and obeys a normal distribution, f₂(.) represents a part that is of the Iₕ and obeys a lognormal distribution, and f₃(.) represents a part that is of the Iₕ and obeys another distribution. Formulas (3) to (5) are mathematical expressions of the fᵢ(.):

$${f}_{1} ( {I}_{h} ) = \frac{1}{\sqrt{2 π} {σ}_{1}} {e}^{- \frac{( {I}_{h} - {μ}_{1} )}{2 {σ}_{1}^{2}}} , \qquad ( 3 )$$

$${f}_{2} ( {I}_{h} ) = \frac{1}{\sqrt{2 π} {I}_{h} {σ}_{2}} {e}^{- \frac{{( {ln I}_{h} - {μ}_{2} )}^{2}}{2 {σ}_{2}^{2}}} , \qquad ( 4 )$$

$${f}_{3} ( {I}_{h} ) = \frac{1}{n b} {\sum }_{{j = 1}^{}}^{n} K ( \frac{{I}_{h} - {I}_{h}^{j}}{b} ) . \qquad ( 5 )$$

In the above formulas, μ₁ and μ₂ represent mathematical expectations of the probability density subfunction, and σ₁ and σ₂ represent standard deviations of the probability density subfunction. K(.) represents a kernel function, and b>0, where b represents a smoothing parameter, which is referred to as a bandwidth or a window. Iₕ^{j} represents a j^{th} sample of the Iₕ in each window, and n represents the total quantity of samples in each window.

A probability density function is non-negative and normative, so the weight coefficient of the probability density subfunction should meet the following formula (6).

In the formula, λ₁=1 or λ₂=1, indicating that the Iₕ obeys a single normal distribution or the lognormal distribution:

$${\sum }_{i = 1}^{3} {λ}_{i} = 1 ( 0 \leq {λ}_{i} \leq 1 ) . \qquad ( 6 )$$

Step 3: The general probability model of the Iₕ is discretized.

Since f₁(.) and f₂(.) are continuous functions and f₃(.) is a discrete function, these two types of functions cannot be added directly by using the following formula (7). Instead, it is necessary to discretize f₁(.) and f₂(.). f₁(.) and f₂(.) can be discretized by discretizing the Iₕ. Therefore, the following discretized general harmonic probability model is obtained:

$$f ( {\tilde{I}}_{h} ) = {\sum }_{i = 1}^{3} {λ}_{i} {f}_{i} ( {\tilde{I}}_{h} ) , \\ {\tilde{I}}_{h} = 0 : 0.01 : max ( {\tilde{I}}_{h} ) . \qquad ( 7 )$$

In the above formula, max(Iₕ) represents the maximum current value of the h-th harmonic.

Step 4: A parameter optimization model of the general probability model is constructed.

It can be seen from the formulas (3) to (7) that by adjusting a value of a parameter set {λ₁, λ₂, λ₃, μ₁, μ₂, σ₁, σ₂, b}, the above discretized general harmonic probability model can fit and approximate a probability distribution function of any random variable. The smoothing parameter b can be set based on experience, and other parameters need to be solved by constructing the parameter optimization model. The parameter optimization model is mainly divided into the following three parts.

1) Determining an Objective Function

The degree of approximation between the general probability model and the actual probability distribution of the Iₕ may be visually reflected by the difference between the mathematical expectation calculated by a general optimization model and the actual value, as well as the difference between the standard deviation calculated by the general optimization model and the actual value. Higher accuracy of the parameter optimization model leads to a smaller difference between the mathematical expectations and a smaller difference between the standard deviations. Therefore, the following two objective functions are constructed in this specification:

$$min {y}_{1} = {( {\sum }_{i = 1}^{3} {λ}_{i} {E}_{i} ( {\tilde{I}}_{h} ) — {E}_{0} ( {\tilde{I}}_{h} ) )}^{2} and \qquad ( 8 )$$

$$min {y}_{2} = ( \sqrt{{\sum }_{i = 1}^{3} {λ}_{i}^{2} {Var}_{i} ( {\tilde{I}}_{h} )} - \sqrt{{{Var}_{0} ( {\tilde{I}}_{h} ) )}^{2}} . \qquad ( 9 )$$

In the above formulas,

$${E}_{1} ( {\tilde{I}}_{h} ) = {μ}_{1} , \\ {Var}_{1} ( {\tilde{I}}_{h} ) = {σ}_{1}^{2} , \qquad ( 10 )$$

$${E}_{2} ( {\tilde{I}}_{h} ) = {e}^{{μ}_{2} + {σ}_{2}^{2} / 2} , \\ {Var}_{2} ( {\tilde{I}}_{h} ) = ( {e}^{{σ}_{2}^{2}} - 1 ) {e}^{2 {μ}_{2} + {σ}_{2}^{2}} , \qquad ( 11 )$$

$${E}_{3} ( {\tilde{I}}_{h} ) = {\sum }_{j = 1}^{{N}_{1}} {\tilde{I}}_{h}^{j} p ( {\tilde{I}}_{h} ) , \qquad ( 12 )$$

$${Var}_{3} ( {\tilde{I}}_{h} ) = {\sum }_{j = 1}^{{N}_{1}} {( {\tilde{I}}_{h}^{j} - {E}_{3} ( {\tilde{I}}_{h} ) )}^{2} p ( {\tilde{I}}_{h}^{j} ) , \qquad ( 13 )$$

$${N}_{1} = length ( {\tilde{I}}_{h} ) , and \qquad ( 14 )$$

$$p ( {\tilde{I}}_{h}^{j} ) = \frac{{f}_{3} ( {\tilde{I}}_{h}^{j} )}{sum ( {f}_{3} ( {\tilde{I}}_{h} ) )} . \qquad ( 15 )$$

A solution to this optimization problem is to combine two minimum objective subfunctions into a minimum objective function, and then an optimization method of a single objective optimization problem is used for solving. The following formula (16) is the combined objective function:

$$min y = \frac{{y}_{1} + {y}_{2}}{2} . \qquad ( 16 )$$

2) Determining Constraints

The constraints include an equality constraint and an inequality constraint based on the forms of the constraints.

Equality constraint: An equality constraint for optimizing the variable λᵢ may be determined according to a formula (6) and is expressed by l:

$$l = {\sum }_{i = 1}^{3} {λ}_{i} - 1 = 0. \qquad ( 17 )$$

Inequality constraint: Based on the optimization parameter set {λ₁, λ₂, λ₃, μ₁, μ₂, σ₁, σ₂, b}, it can be seen that there are mainly two types of inequality constraints. One type of inequality constraint is a value range of the weight coefficient λᵢ. The other type of inequality constraint is a value range that is of the random variable Iₕ and determined by numerical characteristics (μ₁, σ₁) and (μ₂, σ₂) when a single probability density subfunction takes effect.

An inequality constraint of the λᵢ is as follows:

$$\{ \begin{matrix}{g}_{1} = {λ}_{1} \geq 0 \\ {g}_{2} = {λ}_{2} \geq 0 \\ {g}_{3} = {λ}_{3} \geq 0\end{matrix} . \qquad ( 18 )$$

Inequality constraints of {μ₁, μ₂, σ₁, σ₂}: This specification uses a maximum likelihood estimation method to evaluate the numerical characteristics of the Iₕ obeying the single normal distribution or the lognormal distribution and takes the upper and lower confidence limits with a confidence level of 0.95 as value ranges of [μ₁, μ₂, σ₁, σ₂]. Assuming that 95% confidence intervals of {μ₁, —2, σ₁, σ₂} are [θ1, θ2], [θ3, θ4], [θ5, θ6], and [θ7, θ8] respectively, the inequality constraints of the optimization variables {μ₁, μ₂, σ₁, σ₂} can be obtained, namely:

$$\{ \begin{matrix}{g}_{4} = {μ}_{1} - {\hat{θ}}_{1} \geq 0 \\ {g}_{5} = {\hat{θ}}_{2} - {μ}_{1} \geq 0\end{matrix} , \qquad ( 19 )$$

$$\{ \begin{matrix}{g}_{6} = {μ}_{2} - {\hat{θ}}_{3} \geq 0 \\ {g}_{7} = {\hat{θ}}_{4} - {μ}_{2} \geq 0\end{matrix} , \qquad ( 20 )$$

$$\{ \begin{matrix}{g}_{8} = {σ}_{1} - {\hat{θ}}_{5} \geq 0 \\ {g}_{9} = {\hat{θ}}_{6} - {σ}_{1} \geq 0\end{matrix} , and \qquad ( 21 )$$

$$\{ \begin{matrix}{g}_{10} = {σ}_{2} - {\hat{θ}}_{7} \geq 0 \\ {g}_{11} = {\hat{θ}}_{8} - {σ}_{2} \geq 0\end{matrix} . \qquad ( 22 )$$

The parameter optimization model of the general probability model in the present disclosure is composed of the objective function (16) and the constraint conditions (17) to (22).

Step 5: Parameters {λ₁, λ₂, λ₃, μ₁, μ₂, σ₁, σ₂} of the general probability model are solved.

The parameter optimization model in the present disclosure is a constrained optimization problem in an optimization theory. A solution of the parameter optimization model is to convert a constrained problem into an unconstrained problem. Common solving methods include a Lagrange multiplier method, Karush-Kuhn-Tucker (KKT) conditions, a penalty function method, and the like. The parameter optimization model in the present disclosure contains both the equality constraint and the inequality constraint and can be solved directly by using a multiplier method.

It is assumed that the optimization variable set is expressed by γ, namely, γ={λ₁, λ₂, λ₃, μ₁, μ₂, σ₁, σ₂}, and an augmented Lagrange function is defined as J and is expressed is as follows:

$$J ( γ , ω , v , ρ ) = y ( γ ) - vl ( γ ) + \frac{ρ}{2} {l}^{2} ( γ ) + \frac{1}{2 ρ} {\sum }_{q = 1}^{11} \{ {[ max ( 0 , {ω}_{q} - ρ {g}_{q} ( γ ) ) ]}^{2} - {ω}_{q}^{2} \} . \qquad ( 23 )$$

For the J(γ, ω, ν, ρ), only the sufficiently large parameter ρ needs to be taken, and the multipliers ω and ν are continuously corrected to obtain a local optimal solution in the formula (23) by minimizing the J(γ, ω, ν, ρ), where correction formulas of the multipliers ω and ν are as follows:

$$\{ \begin{matrix}{ω}_{q}^{( k + 1 )} = max ( 0 , {ω}_{q}^{( k )} - ρ {g}_{q} ( {γ}^{( k )} ) ) , q = 1 , 2 , L , 11 \\ {v}^{( k + 1 )} = {v}^{( k )} - ρ l ( {γ}^{( k )} )\end{matrix} . \qquad ( 24 )$$

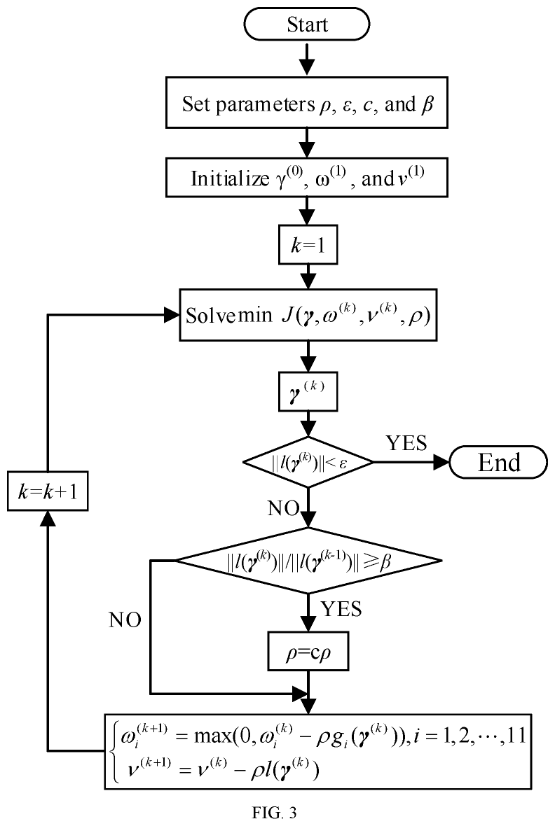

FIG. 3 is a basic flowchart of the multiplier method. The basic procedure of the multiplier method is as follows:

Step 1: Initial point γ⁽⁰⁾, initial multiplier vector estimates ω⁽¹⁾ and ν⁽¹⁾, parameter ρ, allowable error ε (>0), constant c (>1), β (ε(0,1)), and k (=1) are set.

Step 2: γ^{(k-1)} is taken as an initial point, and an unconstrained problem shown in the following formula (25) is solved to obtain solution γ^{(k)}:

min J(γ,ω^{(k)},ν^{(k)},ρ) (25).

Step 3: If ∥l(γ^{(k)})∥<ε, the calculation is stopped, and point γ^{(k)}) is obtained. Otherwise, step 4 is performed.

Step 4: If ∥l(γ^{(k)})∥/∥l(γ^{(k-1)})∥≥β, ρ=cρ is set, and step 5 is performed. Otherwise, step 5 is performed directly.

Step 5: Multipliers ω_{q}^{(k+1)} and ν^{(k+1)} are corrected by using the formula (24); k=k+1 is set, and step 2 is performed.

Step 6: The general probability model of the Iₕ is obtained.

What is claimed is:

1. A method for constructing a general probability model of a harmonic emission level for an industrial load, comprising the following steps:
step 1: extracting harmonic monitoring data of the industrial load to obtain a harmonic characteristic dataset X of a user:
$$X = [ \begin{matrix}{I}_{2}^{1} & {I}_{3}^{1} & L & {I}_{25}^{1} \\ {I}_{2}^{2} & {I}_{3}^{2} & L & {I}_{25}^{2} \\ M & M & M & M \\ {I}_{2}^{N} & {I}_{3}^{N} & L & {I}_{25}^{N}\end{matrix} ] ,$$
wherein N represents a total quantity of sampling points, each column vector in the X represents a harmonic current monitoring sequence, a subscript of the I represents a harmonic order, and a superscript of the I represents a quantity of sampling sequences;
step 2: constructing the general probability model for an h-th harmonic Iₕ in the harmonic characteristic dataset:
$$f ( {I}_{h} ) = {\sum }_{i = 1}^{3} {λ}_{i} {f}_{i} ( {I}_{h} ) ,$$
wherein fᵢ(.) represents a probability density subfunction and λᵢ represents a weight coefficient of the probability density subfunction; f₁(.) represents a part that is of the Iₕ and obeys a normal distribution, f₂(.) represents a part that is of the Iₕ and obeys a lognormal distribution, and f₃(.) represents a part that is of the Iₕ and obeys another distribution; and the fᵢ(.) is expressed as follows:
$${f}_{1} ( {I}_{h} ) = \frac{1}{\sqrt{2 π} {σ}_{1}} {e}^{- \frac{( {I}_{h} - {μ}_{1} )}{2 {σ}_{1}^{2}}} \\ {f}_{2} ( {I}_{h} ) = \frac{1}{\sqrt{2 π} {I}_{h} {σ}_{2}} {e}^{- \frac{{( {lnI}_{h} - {μ}_{2} )}^{2}}{2 {σ}_{2}^{2}}} \\ {f}_{3} ( {I}_{h} ) = \frac{1}{nb} {\sum }_{j = 1}^{n} K ( \frac{{I}_{h} - {I}_{h}^{j}}{b} )$$
wherein μ₁ and μ₂ represent mathematical expectations of the probability density subfunction; σ₁ and σ₂ represent standard deviations of the probability density subfunction; K(.) represents a kernel function, b>0, wherein b represents a smoothing parameter, which is referred to as a window; Iₕ^{j} represents a j^{th} sample of the Iₕ in each window; and n represents a total quantity of samples in each window;
the weight coefficient of the probability density subfunction meets the following formula:
$${\sum }_{i = 1}^{3} {λ}_{i} = 1 ( 0 \leq {λ}_{i} \leq 1 ) ,$$
wherein λ₁=1 represents that the Iₕ obeys a single normal distribution; and A2=1 represents that the Iₕ obeys the lognormal distribution;
step 3: discretizing the general probability model of the Iₕ, wherein
the Iₕ is discretized to discretize the f₁(.) and the f₂(.) to obtain the following discretized general probability model:
$$f ( {\tilde{I}}_{h} ) = {\sum }_{i = 1}^{3} {λ}_{i} {f}_{i} ( {\tilde{I}}_{h} ) , {\tilde{I}}_{h} = 0 : 0.01 : max ( {I}_{h} ) ,$$
wherein max (Iₕ) represents a maximum current value of the h-th harmonic;
step 4: constructing a parameter optimization model of the general probability model, which specifically comprises the following substeps:
step 4.1: constructing an objective function, wherein
a degree of approximation between the general probability model and an actual probability distribution of the Iₕ is reflected by a difference between a mathematical expectation calculated by a general optimization model and an actual value, as well as a difference between a standard deviation calculated by the general optimization model and an actual value, wherein the objective function is as follows:
$$min {y}_{1} = {( {\sum }_{i = 1}^{3} {λ}_{i} {E}_{i} ( {\tilde{I}}_{h} ) - {E}_{0} ( {\tilde{I}}_{h} ) )}^{2} \\ min {y}_{2} = {( \sqrt{{\sum }_{i = 1}^{3} {λ}_{i}^{2} {Var}_{i} ( {\tilde{I}}_{h} )} - \sqrt{{Var}_{0} ( {\tilde{I}}_{h} )} )}^{2}$$
wherein y₁ and y₂ respectively represent mean square errors of a mathematical expectation and a standard deviation of the general probability model; Eᵢ(Īₕ) and E₀(Īₕ) respectively represent a mathematical expectation that is of the Iₕ and calculated by the probability density subfunction, and an actual mathematical expectation of the Iₕ; and Varᵢ(Īₕ) and Var₀(Īₕ) respectively represent a standard deviation that is of the Iₕ and calculated by the probability density subfunction, and an actual standard deviation of the Iₕ; and
min y₁ and min y₂ are combined into a minimum objective function, and the combined minimum objective function is as follows:
$$min y = \frac{{y}_{1} + {y}_{2}}{2}$$
step 4.2: determining constraints, wherein
the constraints comprise an equality constraint and an inequality constraint, wherein
1) an equality constraint for optimizing the weight coefficient λᵢ of the probability density subfunction is determined according to the following formula, and is expressed by l:
$$l = {\sum }_{i = 1}^{3} {λ}_{i} - 1 = 0$$
2) the inequality constraint comprises a value range of the weight coefficient λᵢ and a value range that is of the random variable Iₕ and determined by numerical characteristics (μ₁, σ₁) and (μ₂, σ₂) when the single probability density subfunction takes effect;
an inequality constraint of the λᵢ is as follows:
$$\{ \begin{matrix}{g}_{1} = {λ}_{1} \geq 0 \\ {g}_{2} = {λ}_{2} \geq 0 \\ {g}_{3} = {λ}_{3} \geq 0\end{matrix} ,$$
wherein assuming that 95% confidence intervals of {μ₁, μ₂, σ₁, σ₂} are [\hat{θ}₁, \hat{θ}₂], [\hat{θ}₃, \hat{θ}₄], [\hat{θ}₅, \hat{θ}₆], and [\hat{θ}₇, \hat{θ}₈] respectively, inequality constraints of the optimization variables {μ₁, μ₂, σ₁, σ₂} are as follows:
$$\{ \begin{matrix}{g}_{4} = {μ}_{1} - {\hat{θ}}_{1} \geq 0 \\ {g}_{5} = {\hat{θ}}_{2} - {μ}_{1} \geq 0\end{matrix} , \\ \{ \begin{matrix}{g}_{6} = {μ}_{2} - {\hat{θ}}_{3} \geq 0 \\ {g}_{7} = {\hat{θ}}_{4} - {μ}_{2} \geq 0\end{matrix} , \\ \{ \begin{matrix}{g}_{8} = {σ}_{1} - {\hat{θ}}_{5} \geq 0 \\ {g}_{9} = {\hat{θ}}_{6} - {σ}_{1} \geq 0\end{matrix} , and \\ \{ \begin{matrix}{g}_{10} = {σ}_{2} - {\hat{θ}}_{7} \geq 0 \\ {g}_{11} = {\hat{θ}}_{8} - {σ}_{2} \geq 0\end{matrix} ,$$
wherein g_{q} represents the inequality constraint and q=1, 2, . . . , 11;
step 5: solving parameters {λ₁, λ₂, λ₃, μ₁, μ₂, σ₁, σ₂} of the general probability model, wherein
a constrained problem is converted into an unconstrained problem, and a multiplier method is used for solving, that is, an optimization variable set is defined as γ={λ₁, λ₂, λ₃, μ₁, μ₂, σ₁, σ₂}, and an augmented Lagrange function is defined as J and is expressed is as follows:
$$J ( γ , ω , ν , ρ ) = y ( γ ) - ν l ( γ ) + \frac{ρ}{2} {l}^{2} ( γ ) + \frac{1}{2 ρ} {\sum }_{q = 1}^{11} \{ {[ max ( 0 , {ω}_{q} - ρ {g}_{q} ( γ ) ) ]}^{2} - {ω}_{q}^{2} \} ,$$
wherein y(γ) represents the objective function, l(γ) represents the equality constraint, g_{q}(γ) represents the inequality constraint, ω_{q} represents a Lagrange multiplier of the inequality constraint, and ν represents a Lagrange multiplier of the equality constraint; and
for the J(γ, ω, ν, φ, the sufficiently large parameter ρ is taken, and the multipliers ω and ν are continuously corrected to obtain a local optimal solution by minimizing the J(γ, ω, ν, φ, wherein correction formulas of the multipliers ω and ν are as follows:
$$\{ \begin{matrix}{ω}_{q}^{( k + 1 )} = max ( 0 , {ω}_{q}^{( k )} - ρ {g}_{q} ( {γ}^{( k )} ) ) , q = 1 , 2 , … , 11 \\ {v}^{( k + 1 )} = {v}^{( k )} - ρ l ( {γ}^{( k )} )\end{matrix} ,$$
wherein k in a superscript represents a quantity of corrections; and
step 6: obtaining the general probability model of the Iₕ.

2. The method for constructing the general probability model of the harmonic emission level for the industrial load according to claim 1, wherein in the objective function in step 4.1,
$${E}_{1} ( {\tilde{I}}_{h} ) = {μ}_{1} , {Var}_{1} ( {\tilde{I}}_{h} ) = {σ}_{1}^{2} , \\ {E}_{2} ( {\tilde{I}}_{h} ) = {e}^{{μ}_{2} + {σ}_{2}^{2} / 2} , {Var}_{2} ( {\tilde{I}}_{h} ) = ( {e}^{{σ}_{2}^{2}} - 1 ) {e}^{2 {μ}_{2} + {σ}_{2}^{2}} , \\ {E}_{3} ( {\tilde{I}}_{h} ) = {\sum }_{j = 1}^{{N}_{1}} {\tilde{I}}_{h}^{j} p ( {\tilde{I}}_{h} ) , \\ {Var}_{3} ( {\tilde{I}}_{h} ) = {\sum }_{j = 1}^{{N}_{1}} {( {\tilde{I}}_{h}^{j} - {E}_{3} ( {\tilde{I}}_{h} ) )}^{2} p ( {\tilde{I}}_{h}^{j} ) , \\ {N}_{1} = length ( {\tilde{I}}_{h} ) , and \\ p ( {\tilde{I}}_{h}^{j} ) = \frac{{f}_{3} ( {\tilde{I}}_{h}^{j} )}{sum ( {f}_{3} ( {\tilde{I}}_{h} ) )} .$$

3. The method for constructing the general probability model of the harmonic emission level for the industrial load according to claim 1, wherein the multiplier method in step 5 specifically comprises the following steps:
step a: setting an initial point γ⁽⁰⁾, initial multiplier vector estimates ω⁽¹⁾ and ν⁽¹⁾, a parameter ρ, an allowable error ε (>0), a constant c (>1), β (∈(0,1)), and k (=1);
step b: taking γ^{(k-1)} as an initial point and solving an unconstrained problem shown in the following formula to obtain a solution γ^{(k)}:
min J(γ,ω^{(k)},ν^{(k)},ρ);
step c: if ∥l(γ^{(k)})∥<ε, stopping the calculation and obtaining a point γ^{(k)}); otherwise, performing step d;
step d: if ∥l(γ^{(k)})∥/∥l(γ^{(k-1)})∥≥β, setting ρ=cρ and performing step e; otherwise, performing step e directly; and
step e: using a formula
$$\{ \begin{matrix}{ω}_{q}^{( k + 1 )} = max ( 0 , {ω}_{q}^{( k )} - ρ {g}_{q} ( {γ}^{( k )} ) ) , q = 1 , 2 , … , 11 \\ {v}^{( k + 1 )} = {v}^{( k )} - ρ l ( {γ}^{( k )} )\end{matrix}$$
to correct multipliers ω_{q}^{(k+1)} and ν^{(k+1)}, setting k=k+1 and performing step b.
